(19) United States
(12) Patent Application Publication
(10) Pub. No.: US 2019/0146457 A1
(43) Pub. Date: May 16, 2019

(54) SYSTEM AND METHOD FOR FINITE ELEMENT ANALYSIS OF PARTS HAVING VARIABLE SPATIAL DENSITY GRADED REGIONS PRODUCED VIA 3D PRINTERS

(71) Applicant: Siemens Product Lifecycle Management Software Inc., Plano, TX (US)

(72) Inventor: Louis Komzsik, Huntington Beach, CA (US)

(21) Appl. No.: 16/098,066

(22) PCT Filed: May 16, 2016
(86) PCT No.: PCT/US2016/032702

§ 371 Date: Oct. 31, 2018

(51) Int. Cl. G05B 19/4099

(52) U.S. Cl. CPC G05B 19/4099; G05B 2219/49023

(57) ABSTRACT

A system and method is provided that facilitates finite element analysis of parts having variable spatial density graded regions produced via a 3D printer. A processor may receive at least one input through the input device that specifies a gradation pattern for variation in spatial density in at least one direction in at least one region of a 3D-model of the part. The processor may also carry out the simulation via finite element analysis for the 3D-model of the part based at least in part on simulation parameters and the gradation pattern for the at least one region, to produce simulation results involving the part having graded spatial density in the at least one region. The processor may also generate a configuration for the 3D printer that drives the 3D printer to additively build the part based on the 3D-model having the graded spatial density in the at least one region.

### TECHNICAL FIELD

The present disclosure is directed, in general, to computer-aided design (CAD), computer-aided manufacturing (CAM), computer-aided engineering (CAE), visualization, simulation, and manufacturing systems, product data management (PDM) systems, product lifecycle management (PLM) systems, and similar systems, that are used to create, use, and manage data for products and other items (collectively referred to herein as product systems).

### BACKGROUND

Product systems may be used to carry out simulations using finite element analysis of structures such as manufactured parts. Such product systems may benefit from improvements.

### SUMMARY

Variously disclosed embodiments include data processing systems and methods that may be used to facilitate finite element analysis of parts having variable spatial density graded regions produced via three-dimensional (3D) printers. In one example, a system may comprise at least one input device and at least one processor. The at least one processor may be configured to receive through the at least one input device: at least one input that specifies a 3D-model of a part; at least one input that specifies simulation parameters for carrying out a simulation via a finite element analysis for the 3D-model of the part; at least one input that specifies at least one region of the 3D-model of the part as having graded spatial density; and at least one input that specifies a gradation pattern for variation in spatial density in at least one direction in the at least one region. In addition, the processor may be configured to carry out the simulation via finite element analysis for the 3D-model of the part based at least in part on the simulation parameters and the gradation pattern for the at least one region, to produce simulation results involving the part having the graded spatial density in the at least one region.

In another example, a method for finite element analysis of a part to be built via a 3D printer may comprise through operation of at least one processor: receiving at least one input through the at least one input device that specifies a 3D-model of a part; receiving at least one input through the at least one input device that specifies simulation parameters for carrying out a simulation via a finite element analysis for the 3D-model of the part; receiving at least one input through the at least one input device that specifies at least one region of the 3D-model of the part to be made of a material that varies in spatial density; and receiving at least one input through the at least one input device that specifies a gradation pattern for variation in spatial density in at least one direction in the at least one region. In addition, this described method may include carrying out the simulation via finite element analysis for the 3D-model of the part based at least in part on the simulation parameters and the gradation pattern for the at least one region, to produce simulation results involving the part having the graded spatial density in the at least one region.

A further example may include a non-transitory computer readable medium encoded with executable instructions (such as a software component on a storage device) that when executed, causes at least one processor to carry out this described method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates finite element analysis of parts having variable spatial density graded regions produced via 3D printers.

FIG. 2 illustrates an example chart of a gradation function with respect to two different values (N=1 or 2) for a power parameter of the gradation function.

FIG. 3 illustrates a visual representation of an example linear static simulation using a 3D-model of a part.

FIG. 4 illustrates a visual representation of nominal displacement results for the simulation with the 3D-model of the part with respect to a uniform spatial density.

FIG. 5 illustrates an example visual representation of the part showing a first gradation pattern in which the spatial density of the material of a portion of the part linearly decreases in a longitudinal direction.

FIG. 6 illustrates another example visual representation of the part showing a second gradation pattern in which the spatial density of the material in the portion of the part linearly increases in the longitudinal direction.

FIG. 7 illustrates an example visual representation of displacement results for the simulation with the 3D-model of the part with respect to the gradation pattern in which the spatial density decreases in the longitudinal direction.

FIG. 8 illustrates an example visual representation of displacement results for the simulation with the 3D-model of the part with respect to the gradation pattern in which the spatial density increases in the longitudinal direction.

FIG. 9 illustrates a flow diagram of an example methodology that facilitates finite element analysis of parts having variable spatial density graded regions produced via 3D printers.

FIG. 10 illustrates a block diagram of a data processing system in which an embodiment may be implemented.

### DETAILED DESCRIPTION

Various technologies that pertain to systems and methods that facilitate finite element analysis of parts having variable spatial density graded regions produced via 3D printers will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

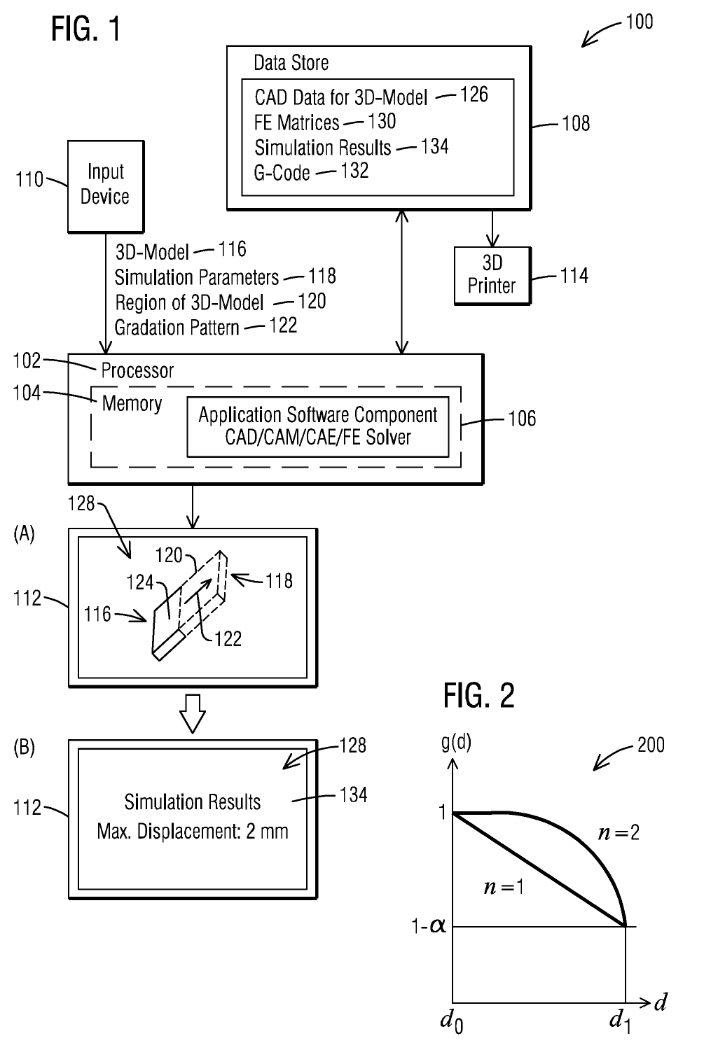

With reference to FIG. 1, an example data processing system 100 is illustrated that facilitates the finite element (FE) analysis of parts having variable spatial density graded regions produced by three-dimension (3D) printers. The system 100 may include at least one processor 102 that is configured to execute at least one application software component 106 from a memory 104 accessed by the processor. The application software component may be configured (i.e., programmed) to cause the processor to carry out various acts and functions described herein. For example, the described application software component 106 may include and/or correspond to one or more components of a PLM software application that is configured to retrieve, generate, and store product data in a data store 108 such as a database (e.g., Oracle, Microsoft SQL Server), hard drive, SSD, memory card or other type of device that stores non-volatile data.

Examples of PLM software applications that may be adapted to carry out the features and functions described herein may include computer-aided design (CAD) software, computer-aided manufacturing (CAM) software, computer-aided engineering (CAE) software, and finite element analysis components and solvers included in the NX suite of applications and Solid Edge Simulation software produced by Siemens Product Lifecycle Management Software Inc., of Plano, Tex., US; and/or the Abaqus Unified FEA suite of software components produced by Dassault Systems, of France. However, it should be appreciated that the systems and methods described herein may be used in other product systems (e.g., a simulation system) and/or any other type of system that generates and stores product data in a database.

It should be understood that a 3D printer corresponds to a machine capable of additively manufacturing (i.e., producing) 3D articles (i.e., a part) by depositing materials which bind together to form the physical structure of the part. Examples of additive manufacturing processes employed by 3D printers to build 3D parts using a high power laser to selectively sinter or melt a powdered material (typically metallic) include: selective laser sintering (SLS), selective laser melting (SLM) and directed energy deposition (DED). Other types of 3D printers may apply other techniques for selectively depositing material to additively build up a part. Also, it should be understand that the phrase to “build up” does not require the material to be built up only in a vertical upward direction, but may include building up the part in a horizontal direction as well as building up the part in a vertical downward direction, depending on the technology of the 3D printer that is used.

The techniques described herein are applicable to 3D printers that are capable of being configured via a configuration 132 (e.g., via G-code or other instructions) to produce parts with graded spatial density in one or more regions. Such graded spatial density corresponds to a variable spatial density of the material (e.g., metal or polymer) being deposited to form a part. The variable spatial density may be achieved via deposited layers of material that include holes that are absent material. Such holes may be achieved by depositing a layer (or part of a layer) with a lattice structure, honeycomb structure, or any other pattern that produces at least a portion of a layer that is not uniformly solid. The spatial density of such a portion of a layer (as defined herein) corresponds to the overall mass of the deposited material in the portion of the layer divided by the volume of the space consumed by the portion of the layer including the holes therein.

Thus, although the density of the material being deposited may be uniform, it should be understood that 3D printers may be configured to build up a part in which the spatial density of each layer or portions of the same layer (i.e., portions of the structure being formed) varies in one or more gradation directions. For example, the number and/or volume of holes produced in a layer, or in different successive layers may incrementally increase or decrease per unit of volume in one or more gradation directions of the part to cause the overall spatial density of the material in these regions to be graded.

The gradation pattern for how the spatial density of the deposited layers varies may be user selectable via the application software component. For example, a part may be built up in which each layer in a region of the part has an increase in spatial density that increases linearly in steps in a common direction (e.g., from the bottom to the top of the region). Conversely, the part may be built up in which each layer in a region has a decrease in spatial density that decreases linearly in steps a common direction (e.g., from the bottom to the top of the region). In a further example, the spatial density of a region of a part may increase (or decrease) in ring shaped steps radial directions with respect to a location of the region. In other examples, the spatial density of the deposited layers may be based on other patterns or mathematical functions which cause variation of spatial density for a region of a material. It should also be appreciated that a region of a part having a graded spatial density may correspond to a sub-portion of the part or the entire part.

The structural integrity and dynamic behavior of a part printed in such way may need to be specifically evaluated using finite element material coefficients (density and Young's modulus) reflecting the spatial density grading. One solution to carry out finite element analysis on such a part is to produce finite element material entities for all elements (e.g., layers, portions of layers) of the part participating in gradation. However, this solution may be highly computational intensive and require a large input data set, for structures additively printed having many levels of spatial density gradation.

The following examples are directed to an alternative solution that may be less computationally intensive. Such alternative solutions may apply a finite element material coefficient modification during the finite element solution automatically by modifying the finite element matrices depending on their location in the part and with respect to a selected gradation pattern (e.g., gradation direction and level). This described solution may be carried out as part of a structural integrity evaluation/simulation of the object in the design phase of the object, which is meant for additive manufacturing, prior to actual printing with a 3D printer. The efficiency (i.e., computational speed) of this described embodiment may enable a user to carry out the solution for several different selectable gradation patterns, in order to determine a gradation pattern that optimizes structural integrity of the part for a given application (e.g., one or more applied loads).

To carry out these features, the described processor 102 may be configured (via the application software component 106) to carry out several functions. Such functions may include receiving at least one input 110 through at least one input device 110 (e.g., a keyboard, mouse, touch screen, touch pad) that specifies a 3D-model 116 of a part 124 intended to be produced via a 3D printer 114. In addition, the functions may include receiving at least one input through the input device 110 that specifies simulation parameters 118 (e.g., levels and direction(s) of loads) for carrying out the simulation via a finite element analysis for the 3D-model of the part.

Further, the functions carried out by the processor 102 may include receiving at least one input through the input device that specifies at least one region 120 of the 3D-model of the part as having gradation in spatial density. In addition, the functions may include receiving at least one input through the input device that specifies a gradation pattern 122 for variation in spatial density in at least one direction in the at least one region, which is capable of being produced by the 3D printer.

The processor may be configured to carry out the simulation via finite element analysis for the 3D-model 116 of the part based at least in part on the simulation parameters 118 and the gradation pattern 122 for the at least one region 120, to produce simulation results 134 involving the part having the graded spatial density in the at least one region.

For example, CAD data 126 corresponding to the 3D-model 116 may be drawn/revised by a user using a CAD component of the application software component 106 and/or may be retrieved from the data store 108. Such CAD data may correspond, for example, to a CAD file in a format such as JT or STEP for storing geometric curves that define the shape of the part used to generate a mesh of the part for carrying out the finite element analysis. In addition, it should also be appreciated that the CAD data, from which the mesh is determined, may be generated from a 3D scan of an existing physical part.

In addition, the application software component may be configured to generate a graphical user interface (GUI) 128 that is outputted through a display device 112. The application software component may be configured to output a visual representation of the 3D-model of the part 124 through the GUI (such as shown in view A of the GUI). The GUI may be configured to enable the user to select the region 120 to have a graded spatial density via a group tool of a CAE component for example. In addition, the GUI may include user interface objects such as text boxes, input boxes, radial buttons, drop-down list boxes, and/or any other user interface element, through which a user may input simulation parameters 118, and data which defines the gradation pattern 122. In addition, as shown in view B of the GUI, the processor may cause the simulation results 134 to be outputted through the display device 112 via the GUI. Although, it should be appreciated that simulation results 134 may also be stored in the data store 108 and/or communicated to a user or other device through a network, for example.

To carry out the finite element analysis, the application software component (such as a CAE component) may be configured to generate a mesh of the 3D-model (e.g., which divides the 3D-model into polyhedral elements). In this described example, the mesh of the selected region for the graded spatial density may be captured in two SETs, one for the grid, and one for the elements.

The application software component may also determine Cartesian coordinates of the selected region's bounding box from the locations of the outmost grid points in x, y, and z directions of the selected region. Both minimal and maximum values of the bounding box may be saved in memory or the data store as x₀, x₁, y₀, y₁, z₀, z₁ for example.

As discussed previously, the gradation pattern may have different forms. Thus an example embodiment of the GUI may enable a user to select a gradation pattern type from a list of possible patterns (e.g., in common direction, in radial directions). In addition, the GUI may enable a user to provide data that defines the direction(s) of the gradation with respect to the selected region. Such a gradation direction, for example, may define whether the spatial density increases or decrease in the selected gradation direction for the region. Also for a radial gradation, the GUI may enable a user to select a central location in the region from which the spatial density increases or decrease in a radial direction with respect thereto in the selected region. In addition, the GUI may enable a user to input parameters for how the level of spatial density changes in the selected direction(s) (e.g., linear, exponential). Further the GUI may enable a user to input parameters for a scale, power, or coefficient of a function that specifies the desired change in spatial density for each additional layer. As used herein, such inputs regarding spatial density correspond to data that defines the gradation pattern referred to herein.

In this example, the application software component may generate and/or update stiffness and mass matrices for the element of the mesh to reflect the inputted gradation pattern with respect to nominal values for the material of the part. In addition, the processor 102 may assemble the applicable global matrices and execute the analysis for the particular simulation or solver that is desired to be carried out. Such matrices 130 may be stored in the data store 108 and/or the memory 104 for use with carrying out the finite element analysis to produce the described simulation results 134. Such simulation results may represent the behavior (e.g., displacements, stress) of the variable spatial density printed object. In addition, in some embodiments, the results of the simulation may be visually displayed, for example, in connection with a 3D-model of the part. Also in some examples, the results of the simulation may include a visual representation of a density map of the part as determined based on the gradation pattern selected by the user for the selected region of the part.

The following provides an example of how the finite element analysis may be carried out with respect to a gradation pattern in the form a gradation function. As discussed previously, in some embodiments, the grading of a material may be in a selected gradation direction, which may be defined as:

v=ai+bj+ck

Thus, a point in space (x_{d}, y_{d}, z_{d}) at a distance (a from an initial location (x₀, y₀, z₀) may be defined as:

x_{d}=a·d+x₀, y_{d}=b·d+y₀, z_{d}=c·d+z₀

An example set of material property values at that location may then be defined as:

P(d)=E(d),G(d), ‘'’ ρ(d),A(d)

for Young's modulus, shear modulus, Poisson's ration, density and heat expansion coefficient, respectively.

In this described example, property values may be gradated by a function as:

P(d)=g(d)Pₙₒₘ

where g(d) corresponds to a gradation function and Pₙₒₘ corresponds to the nominal property values for the particular material type, which may be assigned by the application software component based on the material to be deposited by the 3D printer.

An example gradation function may have the form:

$${g}_{e} ( {d}_{e} ) = 1 - {α ( \frac{{d}_{e} - {d}_{0}}{{d}_{1} - {d}_{0}} )}^{n}$$

where dₑ is the element's centroid distance from the origin of gradation and d₀, d₁ are the distance limits of the gradated area. Here, the expression (dₑ-d₀) represents the current element's distance, which is divided by the expression (d₁-d₀) corresponding to the maximum distance of gradation.

Typical examples for the power (n) may range between 1 and 2. FIG. 2 illustrates an example chart 200 of this gradation function with respect to values for the power where (n=1) and (n=2). However, other powers may be chosen such as an intermediate value (e.g., n=1.5) or larger or smaller values.

To provide the described gradation pattern in this example, the GUI of the application software component may enable the coefficient (a) and power (n) of the gradation function g(d) to inputted and/or updated by a user. In some examples, the application software, may further enable a user to select a particular 3D printer (and/or a type of 3D printer) intended to generate the part, and based thereon provide default values and/or limits for the power value and coefficient of the gradation function g(d) that correspond to the 3D printer that has been selected. Such default values may then be further updated by the user using the GUI.

It should also be appreciated that the gradation function g(d) may correspond to any desirable alternative form in order to produce other gradation patterns by which the spatial density of a part produced via a 3D printer may be varied. For example, the gradation function g(d) may have a form that produces a Gaussian curve, with the spatial density increasing (or decreasing) and peaking (or minimizing) in the middle of the chosen region of the part and then decreasing (or increasing) toward its original starting spatial density.

It should also be appreciated that the GUI of the application software component may enable the gradation pattern to be selected by enabling the type of gradation function g(d) to be selectable by the user through operation of at least one input device. For example, the GUI may provide a listing of selectable gradation functions such as linear, exponential, as well as selectable parameters (e.g., power values for n, coefficient values for a) to tune the gradation function for a particular 3D printer and a desired graded spatial density for a part being produced.

As discussed previously, the material property values of interest may be gradated based on the gradation function g(d). For example, a gradated stiffness matrix may have the form:

$${k}_{e} ( d ) = {\int \int \int }_{{V}_{e}} {B}^{T} D ( E ( {d}_{e} ) ) Bdxdydz$$

where for mathematical simplicity in this example, the subject of gradation is limited to Young's modulus. Since the D stress-strain matrix is linearly proportional to the Young's modulus for the case of linear elastic material, in this example:

D(E(dₑ))=g(dₑ)D(Eₙₒₘ)

which allows the gradated stiffness matrix to be computed as:

$${k}_{e} ( d ) = {g}_{e} ( {d}_{e} ) {\int \int \int }_{{V}_{e}} {B}^{T} D ( {E}_{nom} ) Bdxdydz$$

As a result, the finite element stiffness matrix may be simply scaled.

In addition, the mass matrix is similar as it is linearly proportional with the density as

$${m}_{e} ( d ) = {\int \int \int }_{{V}_{e}} ρ ( {d}_{e} ) {N}^{T} Ndxdydz$$

Hence its gradated form may correspond to:

$${m}_{e} ( {d}_{e} ) = {g}_{e} ( {d}_{e} ) {\int \int \int }_{{V}_{e}} {ρ}_{nom} {N}^{T} Ndxdydz$$

In addition, the procedure may also be extended to a complete set of finite element material properties that are not directly scalable as

$${k}_{e} ( {d}_{e} ) = {\int \int \int }_{{V}_{e}} {B}^{T} D ( E ( {d}_{e} ) , G ( {d}_{e} ) , v ( {d}_{e} ) , A ( d ) ) Bdxdydz$$

It should also be understood that if the temperature coefficient is also graded, example embodiments may use this described evaluation at intermediate stages of the 3D-printing process.

Finite element analysis computations are typically carried out by a software component referred to as a solver that is specifically programmed to carry out such computations. Such a solver may be accessed via an API by other software applications, such as a simulation and/or a CAE application operated by a user to carry out finite element analysis for a desired 3D-model. In example embodiments, such solvers and/or the software which employs such solvers, may be configured to use these example matrix equations and the matrixes generated therefrom to carry out finite element analysis of a 3D-model having a desired spatial density gradation for the material used to produce the part via a 3D printer. An example of a solver that may be configured to carry out the finite element analysis described herein includes the NX Nastran solver produced by Siemens Product Lifecycle Management Software Inc., of Plano, Tex., US.

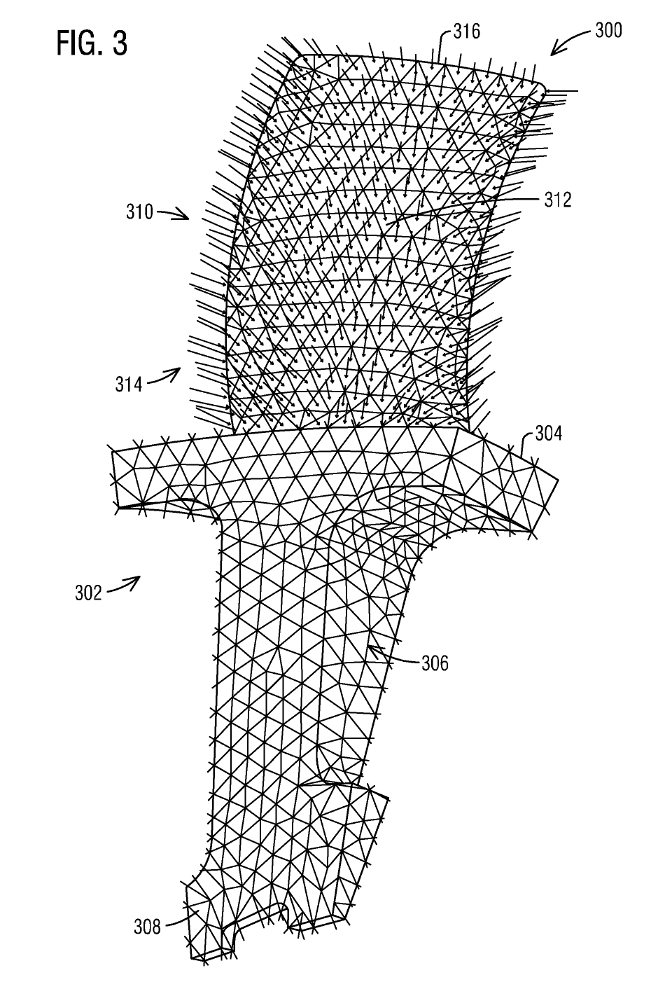

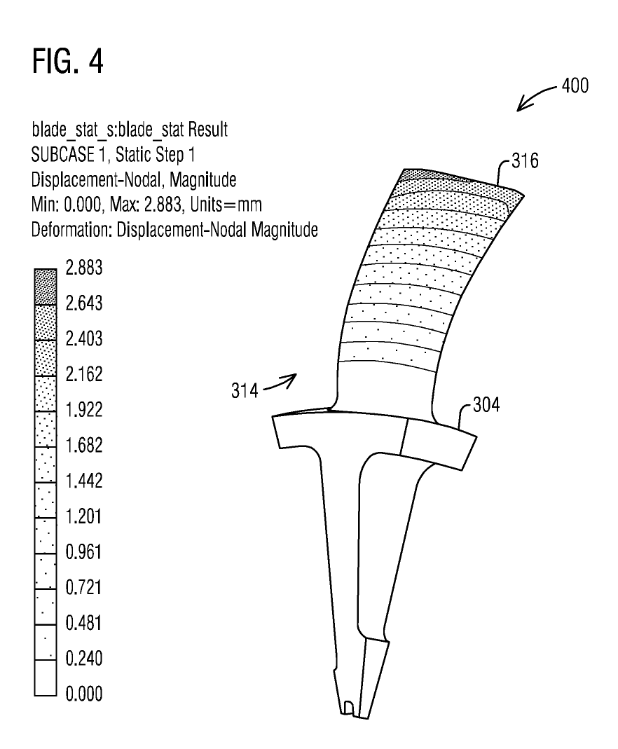

FIGS. 3-8 illustrate examples of a simulation carried out using the described analysis with respect to a part, which in this example corresponds to a turbine blade. FIG. 3 illustrates a visual representation 300 of an example simulation using a 3D-model 302 of the turbine blade 304 showing an example mesh 306 of a 3D-model of the turbine blade. For this described analysis, the simulation was configured via simulation parameters such that the turbine blade was constrained at its root 308 and a pressure 310 was loaded on its leading face 312 at upper region 314 that includes the tip 316 of the blade. FIG. 4 illustrates a visual representation 400 of the nominal displacement result of the blade determined by a solver for this simulation with respect to a uniform spatial density at the upper region 314 of the blade.

In addition, as discussed previously, a 3D printer may be configured to generate a part such as this described turbine blade, in which the spatial density of the material for all or portions of the part are gradated (e.g., via the inclusion of air holes, bubbles, empty volumes, and/or micro-structures in selected regions of the deposited material). Different patterns of spatial density variation may achieve better or worse displacement results when the same simulation described with respect to FIG. 3 is executed. Thus, the described solver may be used to determine the displacement results for the 3D-model 302, but with a gradation of spatial density across the upper region of the blade.

Such a solver may be used to generate displacement results (or levels of stress or other finite element determined properties) for several different gradation patterns in order to identify a gradation pattern that produces relatively better displacement characteristics (or other finite element analysis properties) compared to elements having a uniform spatial density or other gradation pattern for the spatial density of a region of the part.

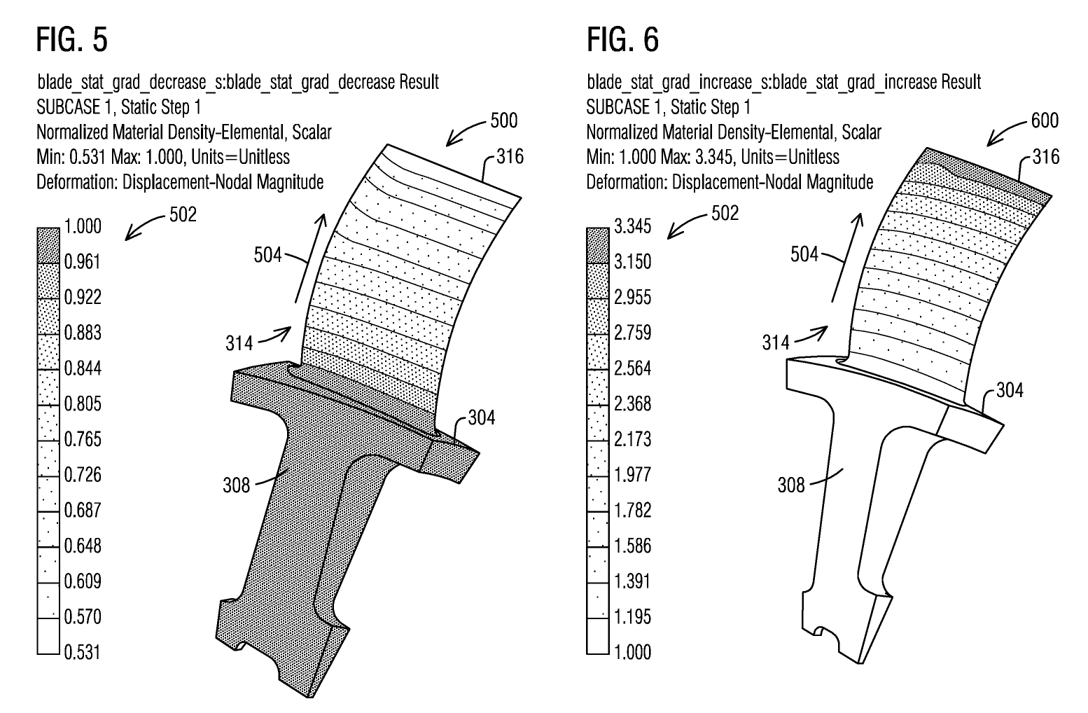

FIG. 5 illustrates an example visual representation 500 of the turbine blade 304 showing a first gradation pattern in which the spatial density of the material in the upper region 314 of the turbine blade linearly decreases in the outward longitudinal direction 504 towards the tip 316 of the turbine blade. FIG. 6 illustrates an another example visual representation 600 of the turbine blade 304 showing a second gradation pattern in which the spatial density of the material in the upper region 314 of the turbine blade linearly increases in the outward longitudinal direction 504 towards the tip 316 of the turbine blade.

In FIGS. 5 and 6, the depicted scales 502, 602 are unitless and are intended to illustrate the relative change in spatial density. Thus, in FIG. 5 the gradation pattern for spatial density in the upper region 314 begins at a value of 1 (adjacent the root) and decreases roughly in half at the tip 316 with a value of 0.531. Conversely, in FIG. 6, the gradation pattern begins at a value of 1 (adjacent the root 308) and increases to more than triple at the tip 316 with a value of 3.345.

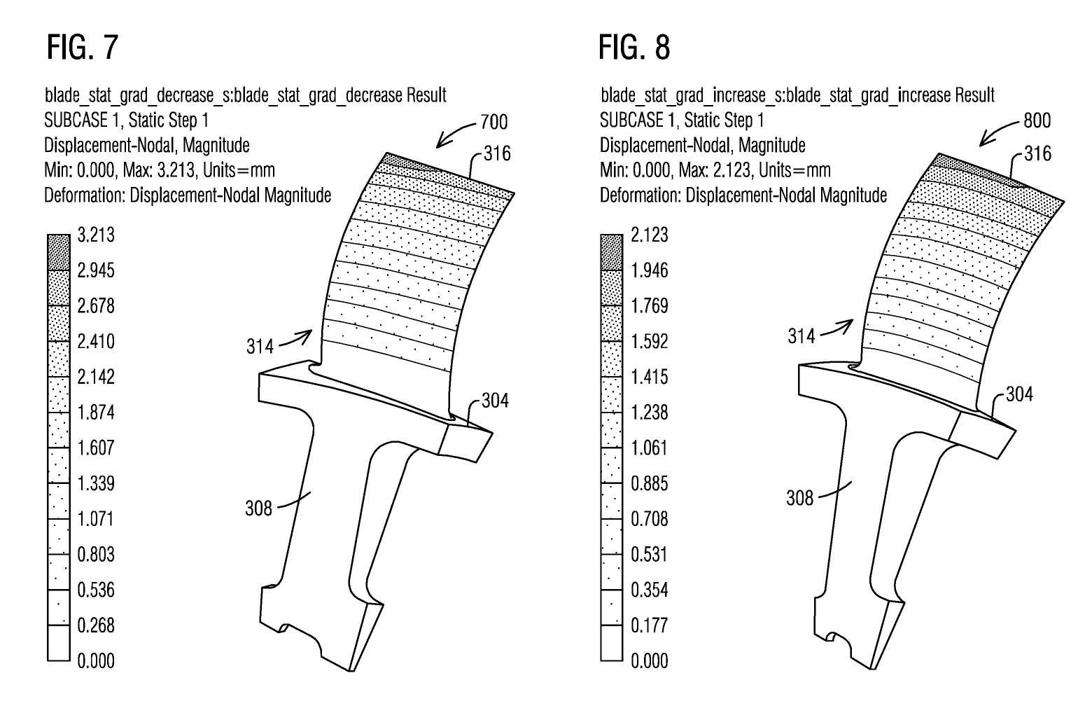

As discussed previously, a solver may be used to generate displacement results for the simulation depicted in FIG. 3 using these different gradation patterns for the spatial density of the material in the upper region 314 of the turbine blade. For example, FIG. 7 illustrates an example visual representation 700 of simulation results for the same 3D-model 302; but with the solver configured to use a gradation pattern (shown in FIG. 5) in which the spatial density decreases towards the tip 316. Also, FIG. 8 illustrates an example visual representation 800 of simulation results for the same 3D-model 302; but with the solver configured to use the gradation pattern (shown in FIG. 6) in which the spatial density increases towards the tip 316.

In FIG. 4, the maximum displacement results generated by the solver for the tip 316 of the blade (as a result of the load) is shown as 2.883 mm for a uniform spatial density. In FIG. 7, the maximum displacement results at the tip 316 of the blade is shown as 3.213 mm for a decreasing spatial density towards the tip. In FIG. 8, the maximum displacement results at the tip 316 of the blade is shown as 2.123 mm for an increasing spatial density towards the tip.

Example embodiments allow for an a priori evaluation of structural integrity of 3D printed parts with graded spatial density. In this example, finite element analysis has been carried out with respect to displacement responsive to loading. However, it should be appreciated that stress values are commensurately changing according to the direction of the spatial density gradation. Thus, simulations may also be carried out with finite element analysis with respect to stress for the 3D-model and one or more gradation patterns for the spatial density of material.

The gradation pattern or nominal pattern (i.e., the uniform spatial density) which produces the best characteristics (e.g., structural integrity) for the part, may then be selected and used to generate a configuration for a 3D printer to build the part. Such a configuration, for example, may cause the 3D printer to additively build the part with a spatial density of material for a desired region of the part that varies according to the selected gradation pattern.

Of the three examples, FIG. 6 depicts the least amount of displacement in response to the same load, which in a gas turbine environment is the more desirable result. Thus based, on a comparison of the simulation results, a design engineer may select the gradation pattern to use to generate a configuration for a 3D printer to build the turbine blade, which corresponds to an increasing spatial density towards the tip. However, it should be appreciated that other simulations such as with respect to stress may be used additionally or alternatively in order to determine which gradation pattern to use to make the actual part.

It should be appreciated that the application software component 106 may include the capability to render the visual representation illustrated in FIGS. 4-8 and output such renderings through the GUI. It should also be appreciated that the visual representation may have one or more different forms, including numerical results displayed in a table.

In example embodiments, the application software component 106 may include one or more components capable of generating the configuration for the 3D printer (e.g., which drives the operation of the 3D printer). Such a configuration, for example, may correspond to G-code that defines the tool paths and other operations used by the 3D printer to produce the part. Such a generated configuration (e.g., G-code) may be saved to one or more data stores 108 such that the configuration is available to be communicated to a 3D printer. For example, the G-code may be saved to a network storage drive and then communicated through a network to a processor associated with a 3D printer that is capable of using the G-code to build the part with the described gradation pattern.

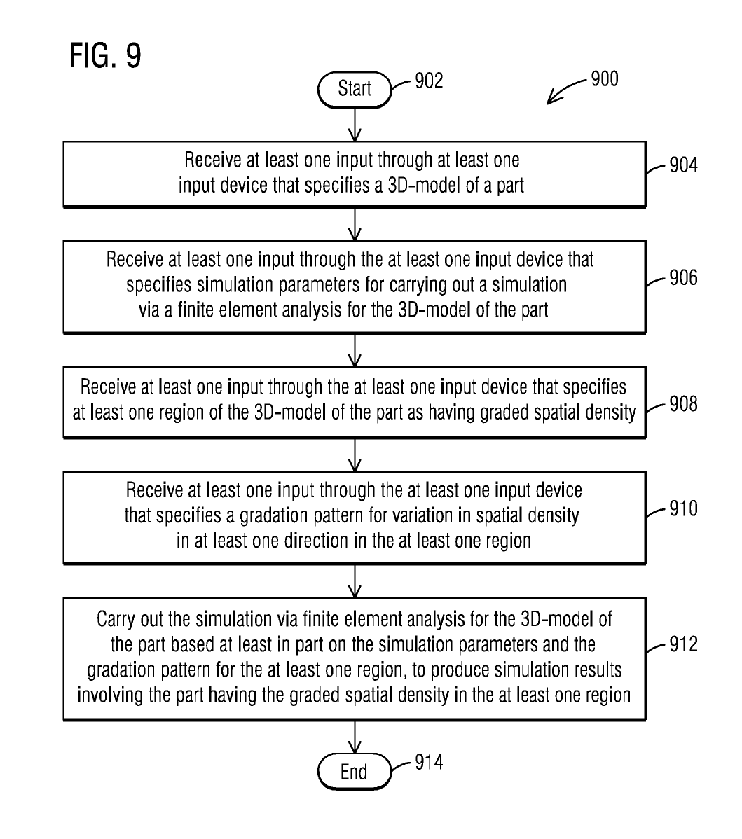

With reference now to FIG. 9, various example methodologies are illustrated and described. While the methodologies are described as being a series of acts that are performed in a sequence, it is to be understood that the methodologies may not be limited by the order of the sequence. For instance, some acts may occur in a different order than what is described herein. In addition, an act may occur concurrently with another act. Furthermore, in some instances, not all acts may be required to implement a methodology described herein.

It is important to note that while the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums include: ROMs, EPROMs, magnetic tape, floppy disks, hard disk drives, SSDs, flash memory, CDs, DVDs, and Blu-ray disks. The computer-executable instructions may include a routine, a sub-routine, programs, applications, modules, libraries, and/or the like. Still further, results of acts of the methodologies may be stored in a computer-readable medium, displayed on a display device, and/or the like.

Referring now to FIG. 9, a methodology 900 is illustrated that facilitates finite element analysis of parts having variable spatial density graded regions produced via 3D printers. The methodology may start at 902 and may include several acts carried out through operation of at least one processor.

These acts may include an act 904 of receiving at least one input through at least one input device that specifies a 3D-model 116 of a part 124. In addition, the methodology may include an act 906 of receiving at least one input through the at least one input device that specifies simulation parameters 118 for carrying out a simulation via a finite element analysis for the 3D-model of the part. Also, the methodology may include an act 908 of receiving at least one input through the at least one input device that specifies at least one region 120 of the 3D-model of the part as having graded spatial density. Further, the methodology may include an act 910 of receiving at least one input through the input device that specifies a gradation pattern for variation in spatial density in at least one direction in the at least one region. The acts carried out in this described methodology 900 may also include an act 912 of carrying out the simulation via finite element analysis for the 3D-model of the part based at least in part on the simulation parameters and the gradation pattern for the at least one region, to produce simulation results involving the part having graded spatial density in the at least one region. At 914 the methodology may end.

It should be appreciated that the methodology 900 may include other acts and features discussed previously with respect to the processing system 100. For example, the at least one input that specifies a gradation pattern may include: at least one gradation direction in which spatial density is varied; and data that selects at least one parameter for a gradation function that defines changes in spatial density in the at least one region in the at least one direction. Such parameters, for example, may include power values for n and/or coefficient values for a for the gradation function g(d) discussed previously. The methodology may further comprise: modifying finite element matrices corresponding to the at least one region of the 3D-model of the part, based on the gradation pattern for the at least one region of the 3D-model of the part.

Also, the described methodology may include updating element stiffness and mass matrices for the finite element analysis to reflect the gradation pattern with respect to nominal values for the material when not graded. One or more types of finite element analyses may then be carried out using the updated element stiffness and mass matrices. Also, the methodology may include reporting the simulation results including at least one of storing the simulation results in a data store, displaying the simulation results through a display device, and communicating the simulation results through a network.

In example embodiments, the simulation parameters may specify at least one load applied to the part for example. Also, the simulation results may be with respect to at least one of displacement, stress, or a combination thereof, and/or any other data regarding structural integrity and dynamic behavior that may be determined by a finite element analysis with respect to a part having a variable spatial density graded region.

Example embodiments of the described methodology may also include generating a configuration for a 3D printer that drives the 3D printer to additively build the part based on the 3D-model with the graded spatial density in the at least one region. As discussed previously, the configuration for the 3D printer may include G-code. Thus, the methodology may further comprise the 3D printer operating to build the part based at least in part on the G-code.

In addition, example embodiments of the described methodology may further comprise: generating a graphical user interface through the display device, which enables a user to select the gradation pattern from a plurality of different gradation patterns, which plurality of different gradation patterns include: spatial density that increases in at least one gradation direction; and spatial density that decrease in at least one gradation direction. Also, the at least one gradation direction may include either a single common gradation direction across the at least one region or radial directions with respect to common location of the at least one region.

As discussed previously, acts associated with these methodologies (other than any described manual acts) may be carried out by one or more processors. Such processor(s) may be included in one or more data processing systems, for example, that execute software components (such as the described application software component) operative to cause these acts to be carried out by the one or more processors. In an example embodiment, such software components may comprise computer-executable instructions corresponding to a routine, a sub-routine, programs, applications, modules, libraries, a thread of execution, and/or the like. Further, it should be appreciated that software components may be written in and/or produced by software environments/languages/frameworks such as Java, JavaScript, Python, C, C#, C++ or any other software tool capable of producing components and graphical user interfaces configured to carry out the acts and features described herein.

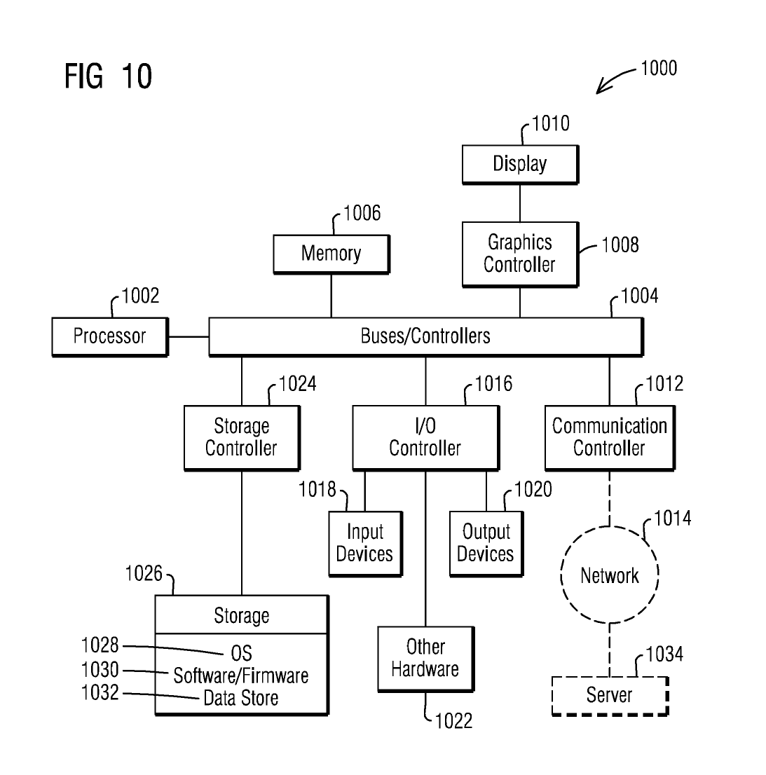

FIG. 10 illustrates a block diagram of a data processing system 1000 (also referred to as a computer system) in which an embodiment can be implemented, for example, as a portion of a product system, and/or other system operatively configured by software or otherwise to perform the processes as described herein. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (connected to speakers and/or microphones). It should also be appreciated that various peripherals may be connected to the I/O controller(s) (via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, it should be appreciated that many devices referred to as input devices or output devices may both provide inputs and receive outputs of communications with the data processing system. For example, the processor 1002 may be integrated into a housing (such as a tablet) that includes a touch screen that serves as both an input and display device. Further, it should be appreciated that some input devices (such as a laptop) may include a plurality of different types of input devices (e.g., touch screen, touch pad, and keyboard). Also, it should be appreciated that other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, which can be any suitable non-transitory machine usable or machine readable storage medium. Examples, include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 1012 may be connected to the network 1014 (not a part of data processing system 1000), which can be any public or private data processing system network or combination of networks, as known to those of skill in the art, including the Internet. Data processing system 1000 can communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a controller, computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be included in a client device that communicates with the server (and/or a virtual machine executing on the server) through a wired or wireless network (which may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean: that an element is relatively near to but not in contact with a further element; or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

1. A system for finite element analysis of a part producible via a 3D printer comprising:
at least one input device;
at least one processor configured to:
receive at least one input through the at least one input device that specifies a 3D-model of a part;
receive at least one input through the at least one input device that specifies simulation parameters for carrying out a simulation via a finite element analysis for the 3D-model of the part;
receive at least one input through the at least one input device that specifies at least one region of the 3D-model of the part as having graded spatial density;
receive at least one input through the at least one input device that specifies a gradation pattern for variation in spatial density in at least one direction in the at least one region; and
carry out the simulation via finite element analysis for the 3D-model of the part based at least in part on the simulation parameters and the gradation pattern for the at least one region, to produce simulation results involving the part having the graded spatial density in the at least one region.

2. The system according to claim 1, wherein the at least one input that specifies a gradation pattern includes:
at least one gradation direction in which spatial density is varied; and
data that selects at least one parameter for a gradation function that defines changes in spatial density in the at least one region in the at least one direction; and
wherein the at least one processor is configured to modify finite element matrices corresponding to the at least one region of the 3D-model of the part, based on the gradation pattern for the at least one region of the 3D-model of the part.

3. The system according to claim 2, wherein the at least one processor is configured to:
update element stiffness and mass matrices for the finite element analysis to reflect the gradation pattern with respect to nominal values for the material when not graded;
carry out one or more types of finite element analyses using the updated element stiffness and mass matrices; and
report the simulation results including at least one of storing the simulation results in a data store, displaying the simulation results through a display device, and communicating the simulation results through a network.

4. The system according to claim 1, wherein the simulation results are with respect to at least one of displacement, stress, or a combination thereof

5. The system according to claim 1, wherein the at least one processor is configured to generate a configuration for the 3D printer that drives the 3D printer to additively build the part based on the 3D-model with the graded spatial density in the at least one region.

6. The system according to claim 5, further comprising the 3D printer, wherein the configuration for the 3D printer includes G-code.

7. The system according to claim 1, further comprising a display device, wherein the at least one processor is configured to generate a graphical user interface through the display device, which enables a user to select the gradation pattern from a plurality of different gradation patterns, which plurality of different gradation patterns include: spatial density that increases in at least one gradation direction; and spatial density that decrease in at least one gradation direction, wherein the at least one gradation direction includes a single common gradation direction across the at least one region or radial directions with respect to common location of the at least one region.

8. A method for finite element analysis of a part producible via a 3D printer comprising:
through operation of at least one processor:
receiving at least one input through at least one input device that specifies a 3D-model of a part;
receiving at least one input through the at least one input device that specifies simulation parameters for carrying out a simulation via a finite element analysis for the 3D-model of the part;
receiving at least one input through the at least one input device that specifies at least one region of the 3D-model of the part as having graded spatial density;
receiving at least one input through the at least one input device that specifies a gradation pattern for variation in spatial density in at least one direction in the at least one region; and
carrying out the simulation via finite element analysis for the 3D-model of the part based at least in part on the simulation parameters and the gradation pattern for the at least one region, to produce simulation results involving the part having the graded spatial density in the at least one region.

9. The method according to claim 8, wherein the at least one input that specifies a gradation pattern includes:
at least one gradation direction in which spatial density is varied; and
data that selects at least one parameter for a gradation function that defines changes in spatial density in the at least one region in the at least one direction; and
further comprising through operation of the at least one processor:
modifying finite element matrices corresponding to the at least one region of the 3D-model of the part, based on the gradation pattern for the at least one region of the 3D-model of the part.

10. The method according to claim 9, further comprising through operation of the at least one processor:
updating element stiffness and mass matrices for the finite element analysis to reflect the gradation pattern with respect to nominal values for the material when not graded;
carrying out one or more types of finite element analyses using the updated element stiffness and mass matrices; and
reporting the simulation results including at least one of storing the simulation results in a data store, displaying the simulation results through a display device, and communicating the simulation results through a network.

11. The method according to claim 8, wherein the simulation results are with respect to at least one of displacement, stress, or a combination thereof.

12. The method according to claim 8, through operation of the at least one processor, generating a configuration for the 3D printer that drives the 3D printer to additively build the part based on the 3D-model with the graded spatial density in the at least one region.

13. The method according to claim 12, wherein the configuration for the 3D printer includes G-code, further comprising the 3D printer operating to build the part based at least in part on the G-code.

14. The method according to claim 8, further comprising through operation of the at least one processor: generating a graphical user interface through the display device, which enables a user to select the gradation pattern from a plurality of different gradation patterns, which plurality of different gradation patterns include: spatial density that increases in at least one gradation direction; and spatial density that decrease in at least one gradation direction, wherein the at least one gradation direction includes a single common gradation direction across the at least one region or radial directions with respect to common location of the at least one region.

15. A non-transitory computer readable medium encoded with executable instructions that when executed, cause at least one processor to:
receive at least one input through at least one input device that specifies a 3D-model of a part;
receive at least one input through the at least one input device that specifies simulation parameters for carrying out a simulation via a finite element analysis for the 3D-model of the part;
receive at least one input through the at least one input device that specifies at least one region of the 3D-model of the part as having graded spatial density;
receive at least one input through the at least one input device that specifies a gradation pattern for variation in spatial density in at least one direction in the at least one region; and
carry out the simulation via finite element analysis for the 3D-model of the part based at least in part on the simulation parameters and the gradation pattern for the at least one region, to produce simulation results involving the part having the graded spatial density in the at least one region.

16. The non-transitory computer readable medium of claim 15, wherein the at least one input that specifies a gradation pattern includes:
at least one gradation direction in which spatial density is varied; and
data that selects at least one parameter for a gradation function that defines changes in spatial density in the at least one region in the at least one direction; and
wherein the executable instructions, when executed, further cause the at least one processor to:
modify finite element matrices corresponding to the at least one region of the 3D-model of the part, based on the gradation pattern for the at least one region of the 3D-model of the part.

17. The non-transitory computer readable medium of claim 16, wherein the executable instructions, when executed, further cause the at least one processor to:
update element stiffness and mass matrices for the finite element analysis to reflect the gradation pattern with respect to nominal values for the material when not graded;
carry out one or more types of finite element analyses using the updated element stiffness and mass matrices; and
report the simulation results including at least one of storing the simulation results in a data store, displaying the simulation results through a display device, and communicating the simulation results through a network.

18. The non-transitory computer readable medium of claim 15, wherein the simulation results are with respect to at least one of displacement, stress, or a combination thereof.

19. The non-transitory computer readable medium of claim 15, wherein the executable instructions, when executed, further cause the at least one processor to generate a configuration for the 3D printer that drives the 3D printer to additively build the part based on the 3D-model with the graded spatial density in the at least one region.

20. The non-transitory computer readable medium of claim 19, wherein the configuration for the 3D printer includes G-code, further comprising the 3D printer operating to build the part based at least in part on the G-code.
